(19) United States
(12) Patent Application Publication
(10) Pub. No.: US 2014/0208023 A1
(43) Pub. Date: Jul. 24, 2014

(54) STORAGE SYSTEM AND CONTROL METHOD FOR STORAGE SYSTEM

(71) Applicant: HITACHI, LTD., Tokyo (JP)

(72) Inventors: Daisuke Orikasa, Odawara (JP); Yutaka Takata, Ninomiya (JP)

(73) Assignee: HITACHI, LTD., Tokyo (JP)

(21) Appl. No.: 13/814,991

(22) PCT Filed: Jan. 24, 2013
(86) PCT No.: PCT/JP2013/000364

§ 371 Date: Feb. 8, 2013

(51) Int. Cl. G06F 3/06

(52) U.S. Cl. CPC G06F 3/0665; G06F 3/0689; G06F 3/0619
USPC 711/114

(57) ABSTRACT

An exemplary storage system of the invention processes requests to access a primary volume and a plurality of secondary volumes forming pairs with the primary volume. In each of the plurality of secondary volumes, address areas are defined which are respectively associated with address areas of the primary volume. Each of the plurality of secondary volumes stores differential data with respect to data in the primary volume. A controller monitors write accesses to the primary volume and the plurality of secondary volumes, and retains a monitoring result. The controller controls, based on, in the monitoring result, presence/absence of past write accesses to a plurality of areas in the primary volume and areas respectively corresponding to the plurality of areas in the plurality of secondary volumes, accesses to the primary volume.

### TECHNICAL FIELD

This invention relates to a storage system and a control method for a storage system.

### BACKGROUND ART

In recent years, the servers/storage systems have come to employ technologies for the virtual machine and the server virtualization due to an increase in simultaneous processing capability brought about by an increase in hardware performance, a cost reduction, easy management, and the like. For example, the virtualization technology by means of the hypervisor enables a plurality of users to use a plurality of guest operating systems (OSs) running on the hypervisor. As a storage solution for covering this background, there is a need for using the snapshot function (for example, refer to Patent Literature 1)

The snapshot function forms a pair of a primary volume and a secondary volume at a certain time point, and copies a slot (referring to data or a storage area in a predetermined size) including data (address area) to be updated in the primary volume to the secondary volume before the update.

For read from the secondary volume, when data at an access destination address does not exist in the secondary volume, the snapshot function reads the data at the access destination address area from the primary volume, and transfers the data to the host. The snapshot function can reduce a storage usage cost as compared with a case where entire data in the primary volume is copied to the secondary volume.

### CITATION LIST

### Patent Literature

[PTL 1] US 2012/0066466 A1

### SUMMARY OF INVENTION

### Technical Problem

The snapshot function can generate a plurality of secondary volumes from one primary volume. A storage apparatus can provide a plurality of users respectively with the plurality of secondary volumes generated by the snapshot function. Each user manages one or a plurality of hosts (such as host computers, virtual machines, and application programs), and each of the hosts makes an access to an allocated secondary volume.

Such an operation that master data (data common to users) is stored in the primary volume, and the latest master data is read from a large number of secondary volumes is assumed. An example of the master data is data in an OS, for example. The master data is common to the hosts, and it is required for the host to acquire the latest master data.

When the master data is updated in the primary volume, which is a case where a patch for the OS is issued, for example, the conventional snapshot function copies, before the update, a slot including data of a corresponding address in the primary volume to the secondary volume. As a result, when the host reads the updated location from the secondary volume, the old master data before the update is transferred to the host.

In order to realize the operation using the conventional snapshot function, namely, in order to transfer, by reading from the secondary volume, the latest master data to the host, it is necessary to generate a new pair each time the master data is updated on the primary volume, which results in a wasteful cost for the storage management.

### Solution to Problem

An aspect of the invention is a storage system, including an interface for transmitting/receiving data to/from a plurality of hosts and a controller for processing requests to access a primary volume and a plurality of secondary volumes forming pairs with the primary volume via the interface. In each of the plurality of secondary volumes, address areas are defined which are respectively associated with address areas of the primary volume. Each of the plurality of secondary volumes stores differential data with respect to data in the primary volume. The controller monitors write accesses to the primary volume and the plurality of secondary volumes, and retains a monitoring result. The controller controls, based on, in the monitoring result, presence/absence of past write accesses to a plurality of areas in the primary volume and areas respectively corresponding to the plurality of areas in the plurality of secondary volumes, accesses to the primary volume.

### Advantageous Effects of Invention

According to an aspect of this invention, the management cost for the storage system providing the plurality of secondary volumes for storing differential data of the primary volume can be reduced.

### BRIEF DESCRIPTION OF DRAWINGS

FIG. 1 is a block diagram schematically illustrating an overview of a configuration of a computer system according to an embodiment of this invention.

FIG. 2 is a diagram illustrating a hardware configuration example of a storage apparatus according to the embodiment.

FIG. 3 is a diagram illustrating an example of a storage control program executed in a storage controller of the storage apparatus according to the embodiment.

FIG. 4 is a diagram schematically illustrating a logical configuration example of volumes in the storage apparatus according to the embodiment.

FIG. 5 is a diagram illustrating a configuration example of a mode management table according to the embodiment.

FIG. 6 is a flowchart of a write processing example directed to a primary volume in a normal mode according to the embodiment.

FIG. 7 is a diagram illustrating a configuration example of a saved-bit management table according to the embodiment.

FIG. 8 is a diagram illustrating a configuration example of a write bit management table according to the embodiment.

FIG. 9 is a flowchart of a write processing example directed to a secondary volume in the normal mode according to the embodiment.

FIG. 10 is a diagram illustrating a volume configuration example in a patch mode according to the embodiment.

FIG. 11 is a flowchart illustrating an example of processing of changing the mode of a primary volume from the normal mode to the patch mode according to the embodiment.

FIG. 12 is a diagram illustrating a configuration example of a copy-to-spare-volume management table according to the embodiment.

FIG. 13 is a flowchart illustrating an example of PVOL write processing in the patch mode according to the embodiment.

FIG. 14 is a flowchart illustrating an example of write processing (SVOL write processing) directed to a secondary volume in the patch mode according to the embodiment.

FIG. 15 is a flowchart illustrating an example of read request processing (SVOL read processing) directed to a secondary volume in the patch mode according to the embodiment.

FIG. 16 is a flowchart illustrating an example of processing of switching the mode of a primary volume from the patch mode to the normal mode according to the embodiment.

### DESCRIPTION OF EMBODIMENTS

A description is now given of an embodiment of this invention referring to the accompanying drawings. This embodiment is simply an example for embodying this invention, and does not limit the technical scope of this invention. In each of the drawings, common components are denoted by the same numerals unless otherwise specified.

This embodiment relates to a storage system. The storage system provides primary volumes and secondary volumes respectively forming pairs with the primary volumes. The secondary volume stores differential data for the primary volume (differential volume). The differential data is different from data in an area in the primary volume corresponding to an area in the secondary volume storing the differential data.

The host makes a read access and a write access to the primary volume, and the host makes a read access and a write access to each of the secondary volumes as well. An access to data common to the primary volume and the secondary volume refers to the primary volume. The secondary volume may store a part of the common data.

The storage system according to this embodiment monitors a write access to a primary volume and a secondary volume, and controls, based on a monitoring result, an access to the primary volume. For example, the storage system determines, in an update of the primary volume, necessity of saving data before the update to the secondary volume based on the monitoring result. As a result, depending on the type of data stored in the primary volume, appropriate access control can be carried out.

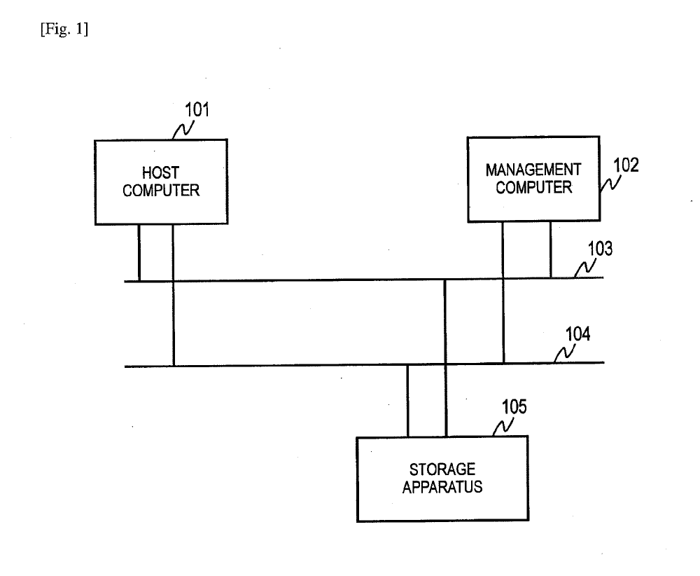

FIG. 1 is block diagram schematically illustrating an overview of a configuration of a computer system according to this embodiment. The computer system includes a host computer 101, a management computer 102, and a storage apparatus 105. The respective numbers of the host computers, the management computers, and the storage apparatus which the computer system can include depend on the design.

The host computer 101, the management computer 102, and the storage apparatus 105 are communicatively coupled to each other by a management network 103. In an example, the management network 103 is an IP network. It should be noted that the management network 103 may be a network other than an IP network as long as the network can be used for the data communication.

The host computer 101, the management computer 102, and the storage apparatus 105 are coupled to each other by a data network 104. The host computer 101 is a computer for making an access to resources of the storage apparatus 105, thereby carrying out tasks. The data network 104 is a network for data communication, and is a storage area network (SAN) in an example. The data network 104 may be a network other than the SAN as long as the network can be used for the data communication. The data network 104 and the management network 103 may be the same network.

For example, a plurality of virtual machines are operating on the host computer 101. For example, the host computer 101 includes a processor, a memory (main storage device), and an interface, and the memory stores virtual machine management information, a plurality of guest OSs, and a virtual machine control program (hypervisor). The virtual machine management information is management information on the virtual machines running on the host computer 101 (virtual machine control program).

The respective guest OSs are operating systems running on the different virtual machines. The guest OSs include OS environment information on the virtual machines. The guest OS uses functions of the virtual machine control program to write and read data to and from the storage apparatus 105. The guest OS reads/writes data from/to a volume by issuing a request to the virtual machine control program.

The virtual machine control program manages an entire virtualization system of the host computer 101. The virtual machine control program identifies, in accordance with a request from the guest OS, a subject volume, and inputs/outputs data to/from the storage apparatus 105. Further, in order to operate the respective virtual machines, the virtual machine control program allocates real resources to the virtual machines and the guest OSs. Virtual machines may not be operating on the host computer 101.

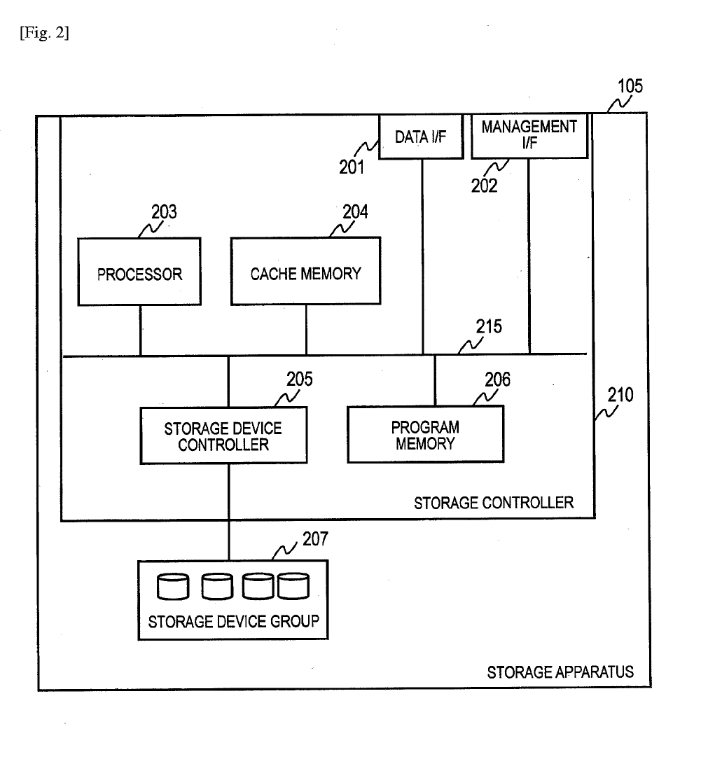

FIG. 2 illustrates a hardware configuration example of the storage apparatus 105. The storage apparatus 105 includes a storage device group 207 and a storage controller 210. For example, the storage device group 207 includes at least one of hard disk drives (HDDs) and solid state drives (SSDs).

The storage controller 210 includes a processor 203, a program memory 206, a cache memory 204, a storage device controller 205, a data interface 201, and a management interface 202. Those components are communicatively coupled to each other by an internal bus 215.

The processor 203 (storage controller 210) executes a storage control program and another necessary program, to thereby realize predetermined functions including control of an I/O request (access request) from the host apparatus 101 and management control of a pool and a volume of the storage apparatus 105. The program memory 206 stores programs in accordance with which the processor 203 operates and data used by the programs.

The cache memory 204 temporarily stores data (user data) on the host computer 101. Specifically, the cache memory 204 temporarily stores the user data (write data) received from the host computer 101, then transfers the write data to the storage device group 207, and temporarily stores the user data (read data) transferred from the storage device group 207 to the host computer 101.

The storage device controller 205 has a function of converting a protocol used for communications between the storage device group 207 and the storage controller 210, such as FC, serial attached SCSI (SAS), or serial advanced technology attachment (SATA), into a protocol used inside the storage controller 210, for example, PCIe.

The data interface 201 and the management interface 202 are respectively coupled to the data network 104 and the management network 103, and each have a function of converting the protocol used for the communications on the respective networks into the protocol used inside the storage controller 210.

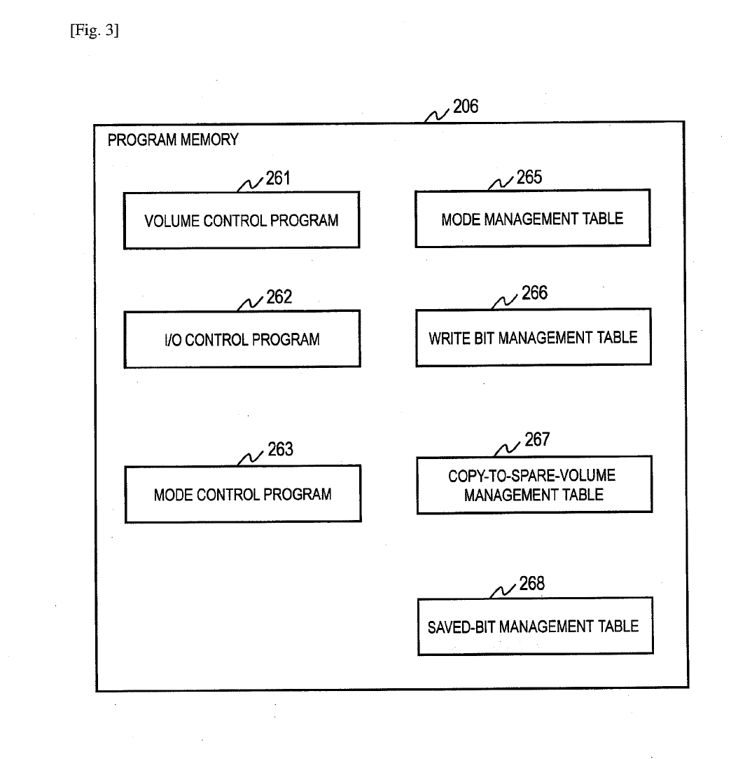

FIG. 3 is a diagram illustrating an example of the storage control program executed in the storage controller 210 of the storage apparatus 105. The storage control program includes a plurality of programs (modules) and information used by the programs, and, in FIG. 3, the programs and the information used thereby are retained in the program memory 206.

In the example illustrated in FIG. 3, the program memory 206 includes a volume control program 261, an I/O (input/output) control program 262, a mode control program 263, a mode management table 265, a write bit management table 266, a copy-to-spare-volume management table 267, and a saved-bit management table 268. In FIG. 3, elements which are not necessary for the description of this embodiment are not shown.

The volume control program 261 generates, deletes, and manages the volume and the pool in the storage apparatus 105. The volumes in the storage apparatus 105 include a virtual volume and a real volume. A description is given later of a volume configuration in the storage apparatus 105. The I/O control program 262 controls an access from the host computer 101 to the volume. The mode management table 265 controls a mode of a primary volume (PVOL). Detailed descriptions are given later of processing by those programs.

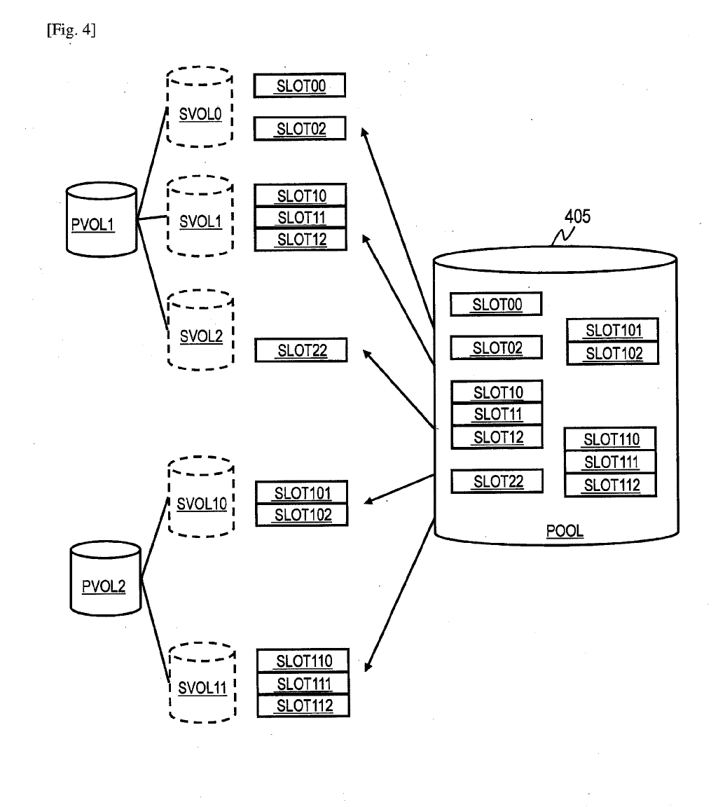

FIG. 4 schematically illustrates a logical configuration example of volumes in the storage apparatus 105. The example includes primary volumes, and a plurality of secondary volumes (SVOLs) each of which forms a pair with the primary volume. As described later, the primary volume includes a plurality of modes. In a normal mode out of the modes, the primary volume and each of the secondary volumes provide the host computer 101 with snapshot data of the primary volume at a specific timing.

In the logical configuration example of FIG. 4, two primary volumes PVOL1 and PVOL2 are generated. Secondary volumes SVOL00 to SVOL02 each forming a pair with the primary volume PVOL1 are generated, and secondary volumes SVOL10 and SVOL11 each forming a pair with the primary volume PVOL2 are generated. For one primary volume, a plurality of secondary volumes are generated at the same time point or at different time points. In FIG. 4, the primary volumes PVOL1 and PVOL2 are in the normal mode.

The secondary volumes SVOL00 to SVOL02 store differential data for the primary volume PVOL1. For example, when data in the primary volume PVOL1 is to be updated, data before the update (differential data) in the primary volume PVOL1 is copied to a part or all of the secondary volumes SVOL00 to SVOL02.

Similarly, the secondary volumes SVOL10 and SVOL11 are differential volumes for the primary volume PVOL2, and when the data in the primary volume PVOL2 is to be updated, data before the update (differential data) in the primary volume PVOL2 is copied to a part or all of the secondary volumes SVOL10 and SVOL11. As described later, according to this embodiment, only a part of data before an update in the primary volume is copied to the secondary volumes.

In the example in FIG. 4, the data copy from the primary volume to the secondary volume is carried out for a slot as a unit. The slot is a unit of a storage area (or data stored therein) for managing the primary volume and the secondary volume, and when a part of data in a slot is updated in the primary volume, entire data of the slot is copied to the secondary volume.

In the example in FIG. 4, a slot SLOTxy of a secondary volume SVOLx corresponds to a slot SLOTy of a corresponding primary volume PVOLw. For example, a slot SLOT02 of the secondary volume SVOL0, a slot SLOT12 of the secondary volume SVOL1, and a slot SLOT22 of the secondary volume SVOL2 correspond to a slot 2 (not shown) of the primary volume PVOL1. A slot SLOT101 of the secondary volume SVOL10 and a slot SLOT111 of the secondary volume SVOL11 correspond to a slot 1 (not shown) of the primary volume PVOL2.

In FIG. 4, only slots which have been copied to the secondary volumes are explicitly illustrated. For example, data in the slots SLOT00 and SLOT02 in the secondary volume SVOL0 has been copied, and data in a slot SLOT01 (not shown in FIG. 4) has not been copied. Data in the slot SLOT22 in the secondary volume SVOL2 has been copied, and data in slots SLOT20 and SLOT21 (not shown in FIG. 4) has not been copied. A page consists of slots.

In the example of FIG. 4, the primary volumes PVOL1 and PVOL2 are real volumes, and the secondary volumes SVOL00 to SVOL02, SVOL10, and SVOL11 are virtual volumes. The storage controller 210 constructs a pool 405 including a plurality of unit real storage areas (pages). For example, a size of one page is larger than a size of one slot and one page consists of a plurality of slots.

For example, the pool 405 includes a plurality of real volumes, and each of the real volumes includes a plurality of pages. The storage controller 210 can construct a plurality of pools. The storage controller 210 constructs a virtual volume to which storage areas (pages) in the pool 405 are dynamically allocated in response to write accesses from the host computer 101, and provides the virtual volume as a secondary volume forming a pair with the primary volume.

Typically, redundant arrays of independent disks (RAID) including a plurality of storage devices provide the pool 405 with a plurality of real volumes (resources). Without constructing real volumes, at least one RAID group may constitute and manage the pool 405.

The storage controller 210 constructs real volumes from real storage areas provided by the storage device group 207. In the pool 405, each of real volumes includes a plurality of pages. A page is a unit of a storage area for managing the virtual volume and the pool. The capacity of the virtual volume (secondary volume) is virtualized. Each time a data storage area is needed in a secondary volume, the storage controller 210 allocates a real page from the pool 405 to the secondary volume.

The storage controller 210 provides the host computer 101 a virtual volume whose capacity is larger than the allocated real storage areas. By means of the virtual volume, an actual capacity required for realizing an apparent capacity of a secondary volume can be reduced. It should be noted that a secondary volume may be a real volume.

According to this embodiment, the host computer 101 can read data from and write (update) data to the primary volumes PVOL1 and PVOL2 and the secondary volumes SVOL00 to SVOL02, SVOL10, and SVOL11. Therefore, the secondary volume stores data before an update of the primary volume, and data written to the secondary volume.

As described later, this embodiment defines different modes of the primary volume, and, in accordance with a selected current mode, controls an access to the primary volumes and the secondary volumes. A first mode is hereinafter referred to as normal mode, and a second mode is hereinafter referred to as patch mode.

The storage controller 210 copies (saves), in the normal mode, for processing all write requests to a primary volume, data before an update to a secondary volume. On the other hand, in the patch mode, the storage controller 210 updates (writes new data to), without copying (saving) data in a specific slot in a primary volume to a secondary volume, the data in the slot.

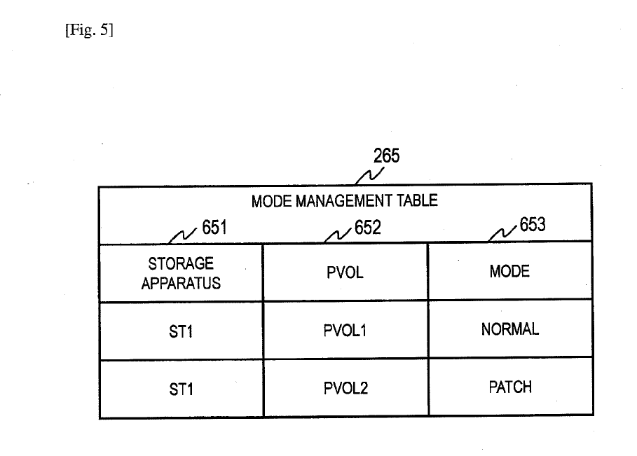

FIG. 5 is a diagram illustrating an example of the mode management table 265. The mode management table 265 manages the mode of each of the primary volumes. The mode management table 265 includes a storage apparatus column 651, a PVOL column 652, and a mode column 653. The storage apparatus column 651 stores an identifier of a storage apparatus, the PVOL column 652 stores an identifier of a primary volume, and the mode column 653 stores a value representing the current mode of the primary volume.

The mode control program 263 generates, updates, and manages the mode management table 265. The mode control program 263 refers to the mode management table 265, thereby recognizing the current mode of each of the primary volumes, and changes, in accordance with other factors such as an instruction from the management computer 102, the mode of each of the primary volumes.

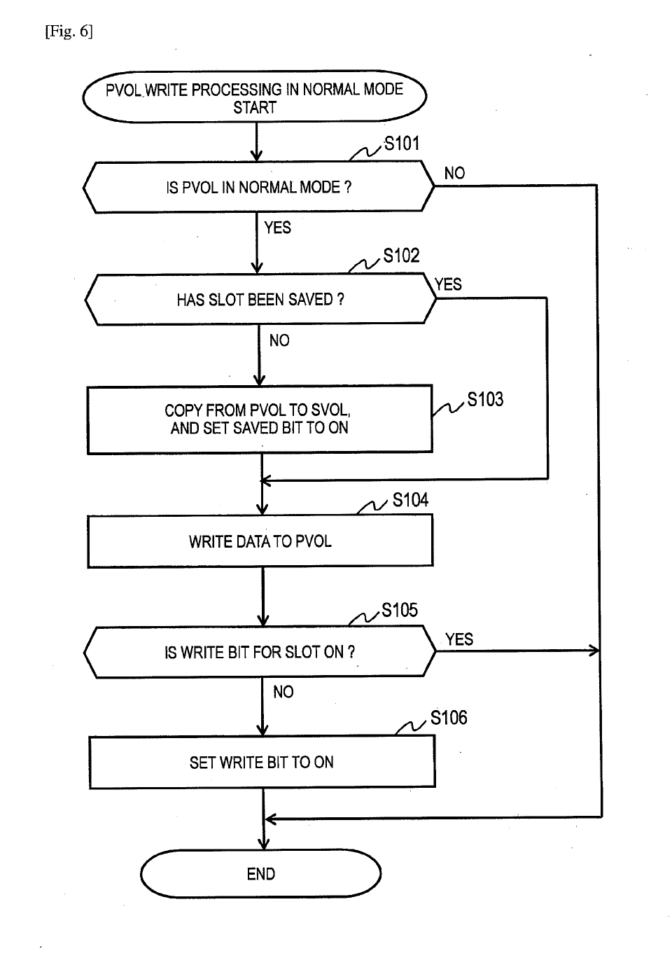

First, a description is given of write processing directed to a primary volume in the normal mode (PVOL write processing in the normal mode). FIG. 6 is a flowchart of a write processing example directed to a primary volume in the normal mode. The I/O control program 262 refers to a write request received from the host computer 101, and identifies a primary volume and an address area of a write destination. The I/O control program 262 refers to the mode management table 265, and determines the current mode of the identified primary volume (S 101).

When the mode column 653 in a corresponding entry of the mode management table 265 represents the patch mode (NO in S101), the I/O control program 262 finishes the flow.

When the mode column 653 represents the normal mode (YES in S101), the I/O control program 262 determines whether or not a slot of the write destination has been saved to any secondary volume, namely, a pool (S 102). The storage controller 210 includes the saved-bit management table 268 for managing whether or not each slot in a primary volume has been saved to a secondary volume (pool).

The I/O control program 262 can recognize, by referring to the saved-bit management table 268, whether or not the data at the creation of the snapshot in the slot of the write destination has been saved to a secondary volume (pool).

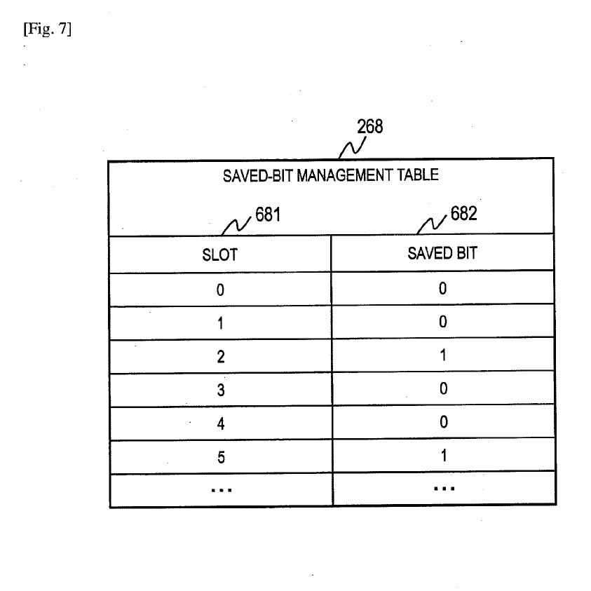

FIG. 7 illustrates a configuration example of the saved-bit management table 268. For example, the volume control program 261 generates, when a primary volume is generated, the saved-bit management table 268 for the primary volume, and stores initial values (0s in this example) in the saved-bit management table 268. The saved-bit management table 268 may store information on a plurality of primary volumes. When the information about primary volumes is stored, the information is managed for each primary volume.

The saved-bit management table 268 includes a slot column 681 and a saved bit column 682. The slot column 681 stores an identifier of a slot of a primary volume, and the saved bit column 682 stores a saved bit. In this example, when the value in the saved bit column 682 is 1, the saved bit of a corresponding slot is ON, which represents that data in the slot has been saved.

When data in a slot has been copied to a secondary volume (pool), and the data is maintained without being changed, namely, when the data before an update in the slot in the primary volume is retained in the pool, the saved bit is set to ON. The update of the saved bit is described later. When a new secondary volume is generated, the values in the saved bit column 682 corresponding to the primary volume are initialized.

When the value of the saved bit column 682 of the slot of the write destination is 1 (saved bit is ON), namely, data in the slot of the write destination has been copied to a secondary volume (pool), and is maintained therein (YES in S102), the I/O control program 262 proceeds to Step S104. When the data in the slot of the write destination has not been saved to a secondary volume (pool) (NO in S 102), the I/O control program 262 proceeds to Step S103.

In Step S103, the I/O control program 262 copies the data in the slot including the access destination area in the primary volume to a secondary volume, and further sets the saved bit of a corresponding entry to ON in the saved-bit management table 268. The I/O control program 262 refers to management information (not shown), thereby identifying the secondary volume to which the slot of the write destination is copied (saved), and further determines whether or not a real page which is to store the copy data of the access destination in the secondary volume has been allocated to the secondary volume from the pool 405.

When a plurality of secondary volumes are generated for the primary volume, the I/0 control program 262 copies data before an update, for example, only to the newest secondary volume. The I/O control program 262 may copy the data before the update to, for example, all secondary volumes to which the data has not been copied before.

The storage controller 210 includes management information indicating a secondary volume corresponding to a primary volume and a time and a date of generation of the secondary volume, and the I/O control program 262 can identify, based on the management information, the newest secondary volume. Management information on a volume configuration including this management information is added, deleted, and updated by the volume control program 261.

For example, the storage controller 210 includes management information indicating secondary volumes and a real page allocated from the pool 405 to each of the secondary volumes. The I/O control program 262 refers to the management information, thereby recognizing whether or not a real page which is to store data of an address area of an access destination (slot of the access destination) of a write request is allocated to a secondary volume. In this way, data write directed to a virtual volume includes an allocation of a real page which is not allocated. This point holds true for the following other flowcharts.

When a real page for storing the copy data is not allocated to the secondary volume, the I/O control program 262 uses the volume control program 261 to allocate a new real page to the secondary volume. The I/O control program 262 copies the data in the slot including the access destination area in the primary volume to the identified secondary volume. Even when a part of the data in the slot is to be updated, the entire data in the slot before the update is copied.

Then, the I/O control program 262 writes the data received from the host computer 101 to the specified address area in the primary volume (S 104). Further, the I/O control program 262 refers to the write bit management table 266, thereby determining whether or not the write bit for the slot is ON (S105).

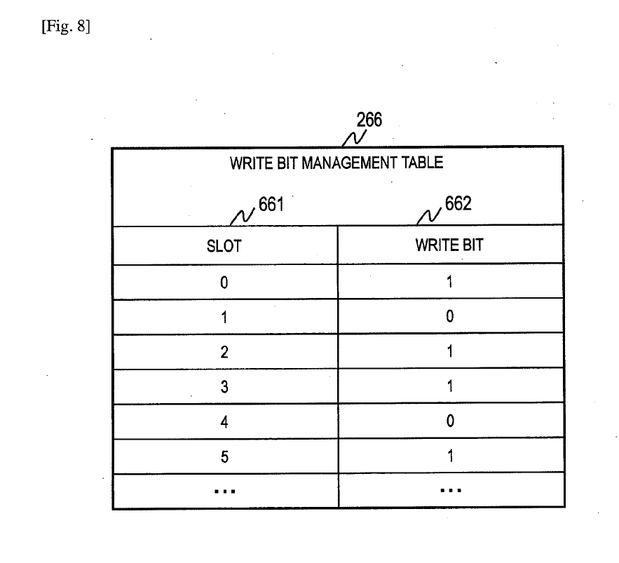

FIG. 8 illustrates a configuration example of the write bit management table 266. For example, the volume control program 261 generates, when a primary volume is generated, the write bit management table 266 for the primary volume, and stores initial values in the write bit management table 266. The write bit management table 266 may store information on a plurality of primary volumes.

The write bit management table 266 includes a slot column 661 and a write bit column 662. The slot column 661 stores an identifier of a slot of a primary volume, and the write bit column 662 stores a write bit.

The I/O control program 262 selects an entry for the write destination slot in the primary volume based on the value in the slot column 661 in the write bit management table 266 to which the access destination primary volume corresponds, and acquires the value in the write bit column 662 in the entry.

When the acquired value is 0, namely, the write bit for the slot is OFF (NO in S 105), the I/O control program 262 sets the write bit for the slot to ON, namely, changes the value of the write bit column 662 to 1 in the entry for the slot (S106). When the write bit is already ON (YES in S 105), Step S106 is skipped.

The write bit management table 266 is referred to in the patch mode. How to use the write bit management table 266 is described in detail later. The I/O control program 262 sets, in writing to a primary volume and a secondary volume, the write bit for a corresponding slot to ON.

As described later, it is estimated that data in a slot for which the write bit is set to ON is not master data common to users, but data unique to a user (user data). The master data is, for example, data in the OS, is not unique to a user, and can be updated by a patch file, but is basically only read out. The user data is individually updated.

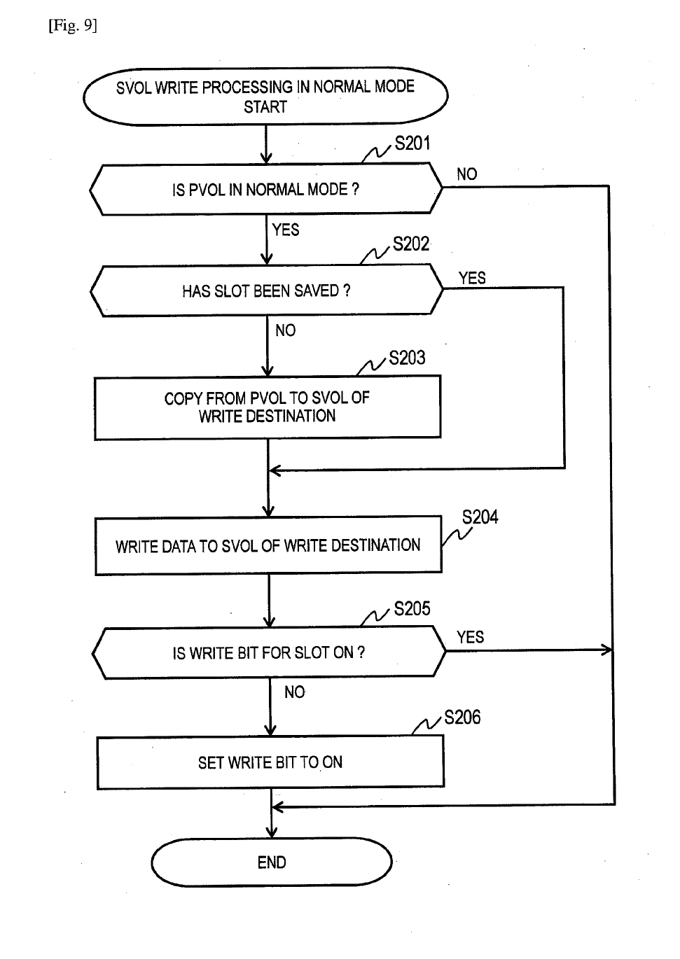

Next, a description is given of write processing directed to a secondary volume in the normal mode. FIG. 9 is a flowchart of a write processing example directed to a secondary volume in the normal mode. The I/O control program 262 refers to a write request received from the host computer 101, and identifies a secondary volume and an address area of a write destination. The I/O control program 262 refers to the mode management table 265, and determines the current mode of a primary volume corresponding to the identified secondary volume (S201).

When the mode column 653 in a corresponding entry of the mode management table 265 represents the patch mode (NO in S201), the I/O control program 262 finishes the flow.

When the mode column 653 represents the normal mode (YES in S201), the I/O control program 262 refers to the saved-bit management table 268, thereby determining whether a slot of the write destination has been saved from a corresponding primary volume to any secondary volume, namely, a pool (S202). This determination method is the same as that in S102 in the flowchart of FIG. 6.

When the data in the slot of the write destination has been copied from the primary volume to a secondary volume (pool) (YES in S202), the I/O control program 262 proceeds to Step S204. When the data in the slot of the write destination has not been saved from the primary volume to a secondary volume (pool) (NO in S202), the I/O control program 262 proceeds to Step S203.

In Step S203, the I/O control program 262 copies the data in the slot including the access destination area in the primary volume to the secondary volume of the write destination. The allocation of a real page which has not been allocated to the secondary volume of the write destination is carried out as described above referring to FIG. 6.

A processing content in Step S204 differs depending on the determination result in Step S202. When the determination result in Step S202 is negative, the I/O control program 262 writes, in the slot copied (S203) from the primary volume to the write destination secondary volume, in an area specified by the received write request from the host computer 101, received write data.

When the determination result in Step S202 is affirmative, the slot in the address area specified by the write request has been copied to any secondary volume. When copied data (from the primtary volume) in the slot is stored in the write destination secondary volume, the I/O control program 262 copies the data in the slot in the write destination secondary volume to a different area in the secondary volume, and writes, in the copied slot, the received write data in the area specified by the received write request from the host computer 101. As a result, the data (backup data) saved from the primary volume is prevented from being changed.

When the copied data in the slot is stored in another secondary volume, the I/O control program 262 copies the data in a corresponding slot from the another secondary volume, and writes, in the copied slot in the write destination secondary volume, the received write data in the area specified by the received write request from the host computer 101.

After Step S204, the I/O control program 262 refers to a write bit management table 266 for the primary volume to which the access destination secondary volume corresponds, and determines whether or not the write bit for the write destination slot is ON (S205).

When the write bit is OFF (NO in S205), the I/O control program 262 sets the write bit for the slot to ON, namely, changes the value of the write bit column 662 to 1 in the entry for the slot (S206). When the write bit is already ON (YES in S205), Step S206 is skipped.

In the above-mentioned example, in Step S204, when data in a write destination slot is saved to a write destination secondary volume, both data before an update and data after an update in the same slot are retained in the write destination secondary volume, and when the data in the slot has been copied from another volume to the write destination secondary volume, the copied data is not maintained, and the copied data is overwritten with the new data (refer to the above description of Step S204).

In another example, the I/O control program 262 copies, in the write processing to a secondary volume, from another volume (primary volume or secondary volume) to two different areas in a write destination secondary volume, writes received write data in one of the copied slots, and maintains data in the other copied slot. In this example, the I/O control program 262, in Step S203, sets the saved bit for the slot to ON.

As described above, in the example where the slot data copied from the another volume is updated, and the data before the update is not maintained in the write destination volume, the saved bit is not set to ON (refer to the above description of Step S203).

In the another example, the write processing to a secondary volume in the normal mode copies data in a slot to a different area in a write destination volume, and retains both a slot after the update and a slot before the update. The data in the slot copied from the primary volume to the secondary volume is maintained without change, and the I/O control program 262 thus sets, in Step S203, the saved bit to ON.

Though the another example uses more real volume than in the example, even when data in a write destination slot is acquired from any volume, data before the update is maintained in a write destination secondary volume, and a processing configuration (program or logic circuit) can be thus simplified more.

A description is now given of processing for a read request directed to a secondary volume in the normal mode. The I/O control program 262 refers to a read request received from the host computer 101, and identifies an access destination volume and an address area. The I/O control program 262 identifies a volume storing data of a slot in the specified address area. For example, the storage controller 210 includes management information representing volumes storing data in each of the slots in a secondary volume.

The data in the specified address area is stored in the read subject secondary volume, a primary volume, or other secondary volume. The I/O control program 262 refers to the management information, thereby acquiring the data in the specified address area from the identified volume, and transfers the acquired data to the host computer 101.

As described above, the I/O control program 262 (storage controller 210) sets, in the write processing directed to a primary volume or the write processing directed to a secondary volume in the normal mode, a corresponding write bit to ON.

It is estimated that a volume access in the normal mode is caused by a user request (request from an application program). Thus, it is estimated that data subject to an update (write) in the normal mode is not master data common to uses, but data unique to a user. The storage controller 210 can provide, by referring to a write bit, and controlling an access to a primary volume, master data and user data with appropriate volume management.

This embodiment controls, by referring to the write bit in the write processing directed to a primary volume in the patch mode, the copy (backup) of data before an update. The storage controller 210 can control presence/absence of a copy to a secondary volume (pool) of data before an update depending on whether the data is master data or user data, and can provide an appropriate copy (backup) depending on data in a primary volume.

As described above, the patch mode is a mode used to update master data in a primary volume, and is selected, for example, to update an OS by means of a patch file. The update of the master data should be applied to a plurality of users (such as virtual machines) using the master data. When an access is directed to a secondary volume, in order that the master data after the update is referred to, copy data of the master data before the update is not retained in the secondary volume (pool), and the master data in the primary volume is updated.

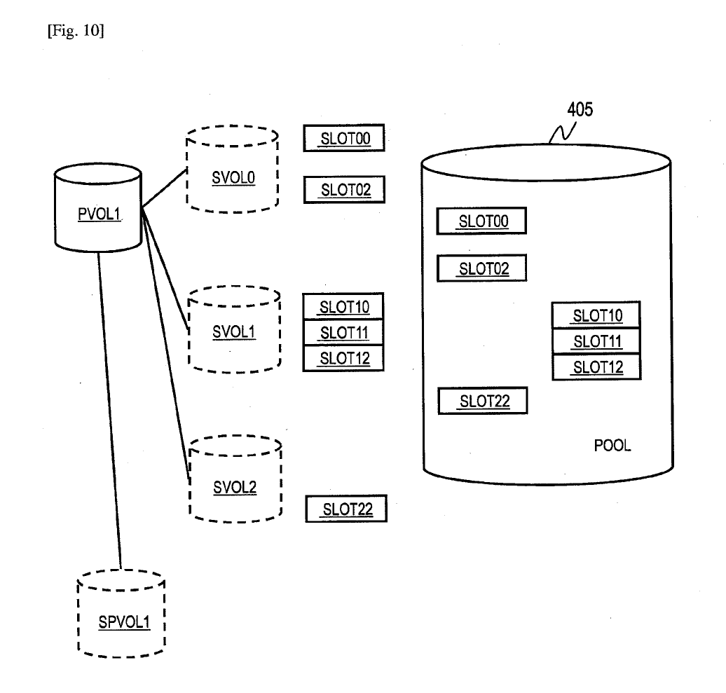

A description is now given of write processing and read processing in the patch mode in the primary volume. FIG. 10 illustrates a volume configuration example in the patch mode. FIG. 10 illustrates only the primary volume PVOL1 and volumes relating thereto. The primary volume PVOL1 is in the patch mode. In the volume configuration in the patch mode of FIG. 10, a different point from the volume configuration in the normal mode of FIG. 4 is that a spare volume SPVOL1 is generated.

In the patch mode of the primary volume, a spare volume (SPVOL) is generated for the primary volume. For at least one primary volume, at least one spare volume is generated. In the following, a description is given of an example where, for one primary volume, one spare volume is generated.

The spare volume forms a copy pair along with the primary volume. In this example, the spare volume is, as in a secondary volume, a virtual volume. The spare volume may be a real volume. It should be noted that, in the patch mode, the storage controller 210 may not use a spare volume.

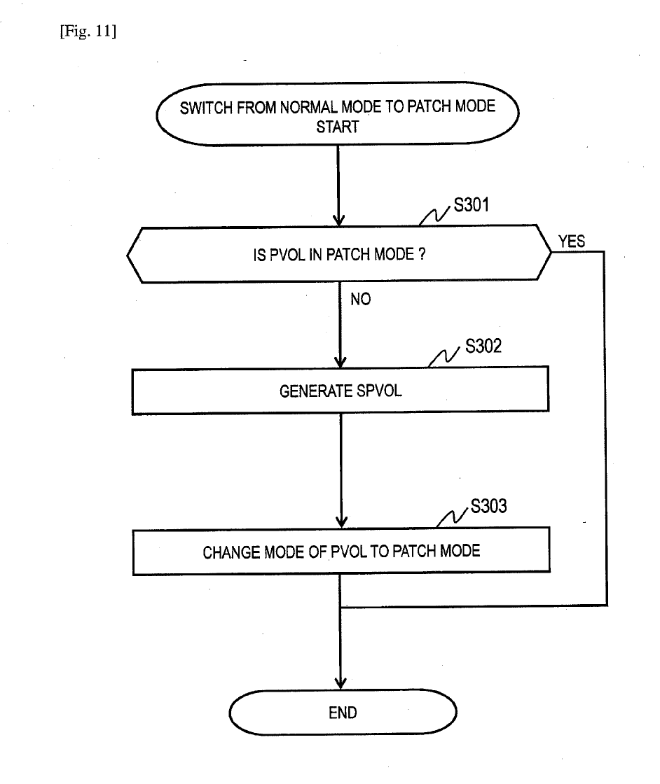

First, a description is given of a transition from the normal mode to the patch mode. FIG. 11 is a flowchart illustrating an example of processing of changing the mode of the primary volume from the normal mode to the patch mode.

The management computer 102 instructs, in response to an input from an administrator, the storage apparatus 101 to control the specified primary volume to transition from the normal mode to the patch mode. The management I/F 202 receives the instruction, and the mode control program 263 is activated. The mode control program 263 may be activated by other conditions.

The mode control program 263 refers to the mode management table 265, and determines the mode of the specified primary volume (S301). The mode control program 263 acquires a value from the mode column 653 from a corresponding entry, and when the acquired value represents the patch mode (YES in S301), finishes the flow.

When the acquired value represents the normal mode (NO in S301), the mode control program 263 controls the volume control program 261 to generate a spare volume (S302). The volume control program 261 receives the instruction to generate a spare volume for the specified primary volume from the mode control program 263, and follows the instruction to generate a virtual volume forming a pair along with the specified primary volume. Further, the volume control program 261 generates the copy-to-spare-volume management table 267 for the pair.

Then, the mode control program 263 changes the value of the mode column 653 to a value representing the patch mode in the corresponding entry of the mode management table 265 (S303).

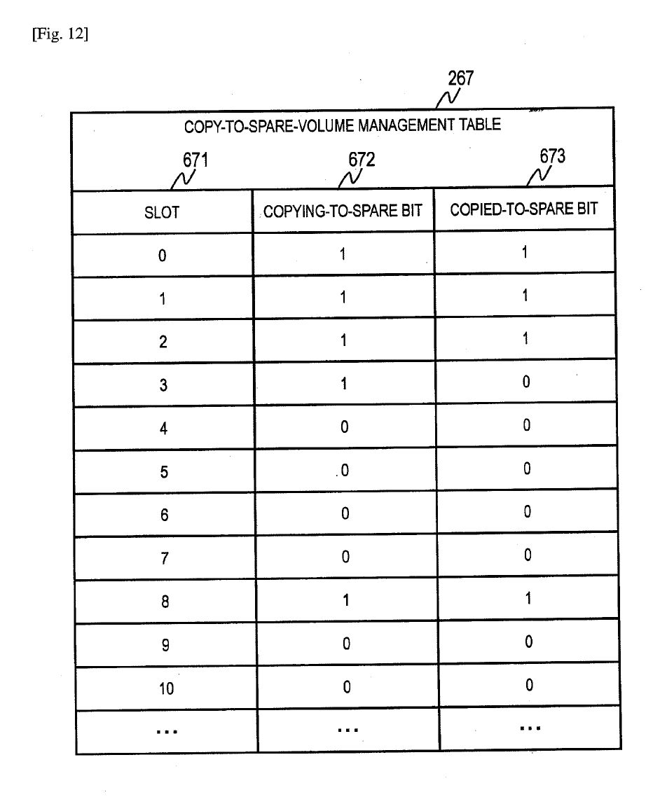

A description is now given of write processing directed to a primary volume (PVOL write processing) in the patch mode. In the patch mode, in order to control the access to a primary volume, the copy-to-spare-volume management table 267 is used. FIG. 12 illustrates a configuration example of the copy-to-spare-volume management table 267.

The copy-to-spare-volume management table 267 includes a slot column 671, a copying-to-spare bit column 672, and a copied-to-spare bit column 673. In this example, a copy-to-spare-volume management table 267 is prepared for each of primary volumes. A copy-to-spare-volume management table 267 may include information on a plurality of primary volumes.

The slot column 671 stores an identifier of a slot in a primary volume. The copying-to-spare bit column 672 stores a copying bit corresponding to each slot. The copying bit represents whether or not data in the slot is being copied from the primary volume to a spare volume.

The copied-to-spare bit column 673 stores a copied bit corresponding to each slot. The copied bit represents whether or not data in the slot has been copied from the primary volume to the spare volume. In place of the copying bit and the copied bit, a value including two or more bits may be used.

When the data in the slot is in a state before the copy to the spare volume, the copying-to-spare bit and the copied-to-spare bit for the slot are OFF (0). When the data in the slot is being copied to the spare volume, the copying-to-spare bit is ON (1), and the copied-to-spare bit is OFF (0). When the data in the slot has been copied to the spare volume, the copying-to-spare bit and the copied-to-spare bit for the slot are ON (1).

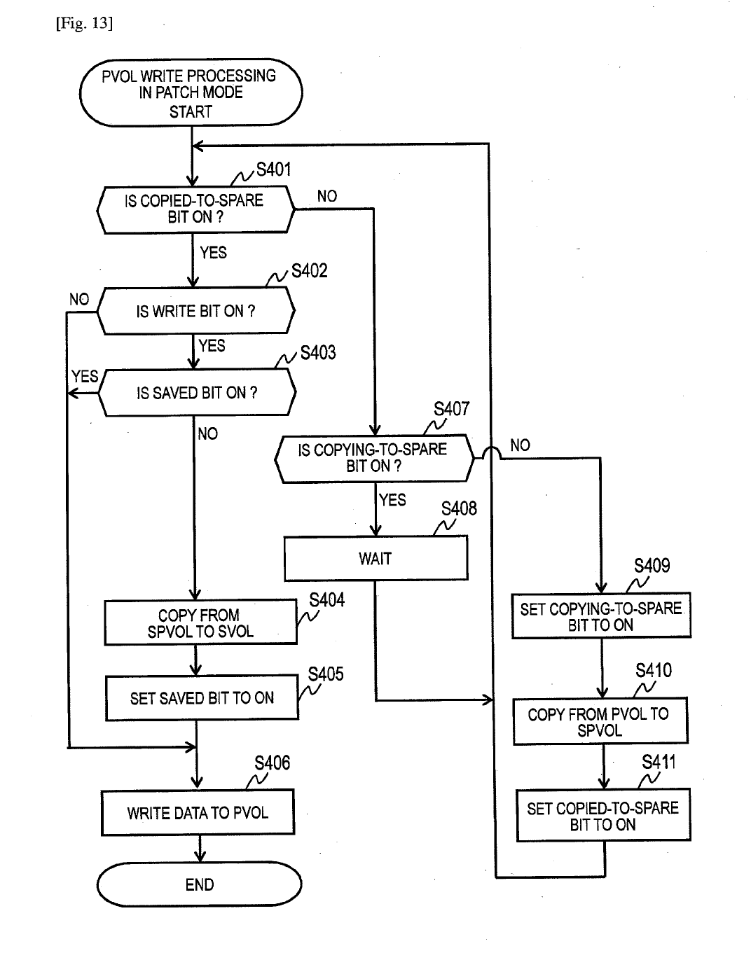

FIG. 13 is a flowchart illustrating an example of PVOL write processing in the patch mode. The I/O control program 262 refers to the mode management table 265, thereby recognizing the mode of a primary volume subject to a write request, and when the mode is a patch mode, the I/O control program 262 carries out the flow (FIG. 13).

The I/O control program 262 refers to the write request received from the host computer 101, and identifies a primary volume and an address area of a write destination. The I/O control program 262 identifies a slot corresponding to the specified address area (in this example, it is assumed that the area is included in one slot).

The slot size is prescribed, and, based on a specified start address and data length, a slot corresponding to the address area can be identified. When an address area extends to a plurality of slots, the I/O control program 262 carries out steps described below for each of the slots.

The I/O control program 262 refers to the copy-to-spare-volume management table 267, thereby determining whether or not the copied-to-spare bit for the slot is ON, namely, whether or not data in the slot has been copied to the spare volume (S401).

When the copied-to-spare bit for the slot is OFF, namely, the data in the slot has not been copied to the spare volume (NO in S401), the I/O control program 262 determines, in the copy-to-spare-volume management table 267, the value of the copying-to-spare bit for the slot (S407).

When the value of the copying-to-spare bit is ON, namely, the data in the slot is being copied to the spare volume (YES in S407), the I/O control program 262 waits for a predetermined time (S408), and then returns to Step S401. When the value of the copying-to-spare bit is OFF, namely, the data in the slot is not being copied to the spare volume (NO in S407), the I/O control program 262 sets, in the copying-to-spare bit column 672 of the copy-to-spare-volume management table 267, the copyingto-spare bit for the slot to ON (S409).

Then, the I/O control program 262 copies the data in the slot in the primary volume (PVOL) to the spare volume (SPVOL) (S410). When the copy has been completed in Step S409, the I/O control program 262 sets, in the copied-to-spare bit column 673 of the copy-to-spare-volume management table 267, the copied-to-spare bit for the slot to ON (S411). Then, the I/O control program 262 returns to Step S401.

In Step S401, when the copied-to-spare bit for the slot is ON, namely, the data in the slot has been copied to the spare volume (YES in S401), the I/O control program 262 refers to the write bit management table 266, thereby determining whether or not the write bit for the slot is ON, namely, the data in the slot is master data or user data (S402).

When the write bit is ON (YES in S402), the I/O control program 262 refers to the saved bit management table 268, thereby determining whether or not the saved bit for the slot is ON, namely, whether or not the data in the slot has been saved to a secondary volume (pool) (S403).

When the saved bit is OFF, namely, the data in the slot has not been saved to a secondary volume (pool) (NO in S403), the I/O control program 262 copies the data in the slot copied to the spare volume to a secondary volume (pool) (S404). For example, the data is copied to the newest secondary volume.

The I/O control program 262 further sets, in the saved-bit management table 268, the saved bit for the slot to ON (S405). After Step S405, the I/O control program 262 writes, to the write destination slot in the primary volume, the data received from the host computer 101 (S406). In the write processing directed to a primary volume in the patch mode, the write bit for the write destination slot is not changed.

When the determination result in Step S402 is negative (NO in S402), or the determination result in Step S403 is affirmative (YES in S403), Step S404 and Step S405 are skipped.

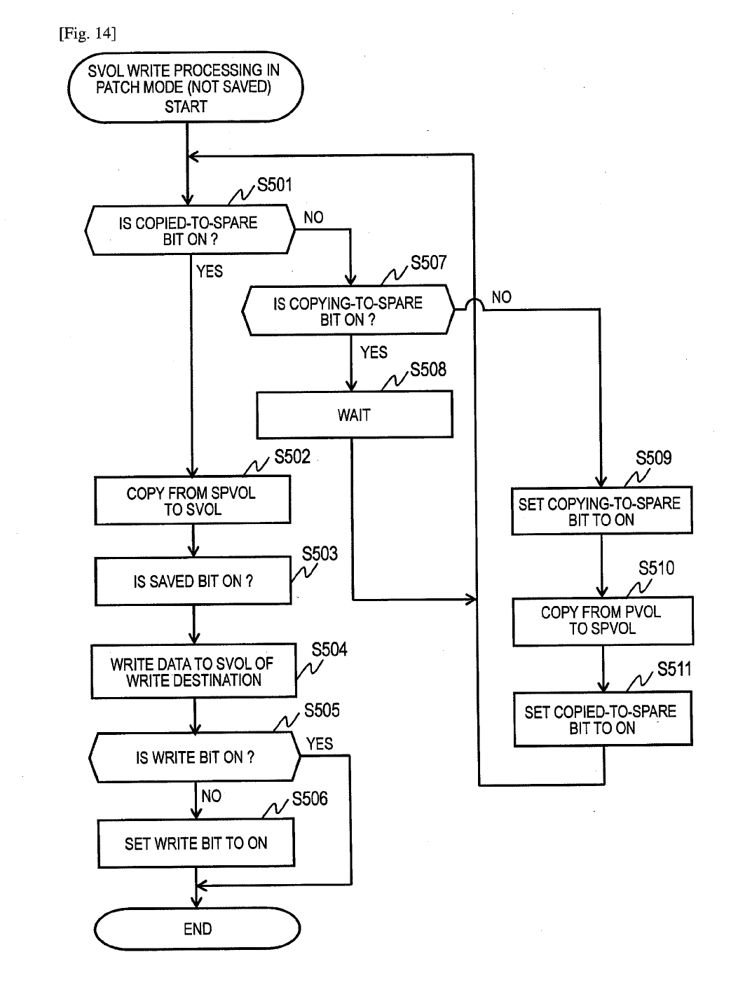

Now, referring to a flowchart of FIG. 14, a description is given of an example of write processing directed to a secondary volume (SVOL write processing) in the patch mode. The SVOL write processing described here is write processing directed to a slot having data which is not saved from a primary volume to the secondary volume (pool). In other words, the SVOL write processing is SVOL write processing involving data copy from the primary volume to the write destination secondary volume.

For example, in a configuration where, in the normal mode, the SVOL write processing maintains data copied from another volume to a write destination secondary volume without changing the data, after the write destination secondary volume is generated, when write to the slot (update of the slot) in the primary volume has not been carried out, this processing is carried out.

Alternatively, in a configuration where, in the normal mode, the SVOL write processing doubly copies a slot from another volume to a write destination secondary volume, and maintains one of the two pieces of copy data as backup data, when write to the slot in the primary volume and the secondary volume has not been carried out, this processing is carried out.

In FIG. 14, the I/O control program 262 refers to the write request received from the host computer 101, and identifies a secondary volume and an address area of the write destination. The I/O control program 262 identifies a slot corresponding to the specified address area. On this occasion, it is assumed that the area is included in one slot. When an address area extends to a plurality of slots, the I/O control program 262 carries out steps described below for each of the slots.

The I/O control program 262 refers to the copy-to-spare-volume management table 267, thereby determining whether or not the copied-to-spare bit for the slot is ON (S501).

When the copied-to-spare bit for the slot is OFF, (NO in S501), the I/O control program 262 determines, in the copy-to-spare-volume management table 267, the value of the copying-to-spare bit for the slot (S507).

When the value of the copying-to-spare bit is ON, (YES in S507), the I/O control program 262 waits for a predetermined time (S508), and then returns to Step S501. When the value of the copying-to-spare bit for the slot is OFF, (NO in S507), the I/O control program 262 sets, in the copying-to-spare bit column 672 of the copy-to-spare-volume management table 267, the copying-to-spare bit for the slot to ON (S509).

Then, the I/O control program 262 copies the data in the slot in the primary volume (PVOL) to the spare volume (SPVOL) (S510). When the copy has been completed in Step S508, the I/O control program 262 sets, in the copied-to-spare bit column 673 of the copy-to-spare-volume management table 267, the copied-to-spare bit for the slot to ON (S511). Then, the I/O control program 262 returns to Step S501.

When, in Step S501, the copied-to-spare bit for the slot is ON (YES in S501), the I/O control program 262 copies data in the slot from the spare volume (SPVOL) to the write destination secondary volume (SVOL) (S502). The I/O control program 262 further sets, in the saved-bit management table 268, the saved bit (value in the saved bit column 682) for the slot to ON (S503).

The I/O control program 262 updates, in the write destination secondary volume (SVOL), the data in the slot copied from the spare volume by write data received from the host computer 101 (S504).

After Step S504, the I/O control program 262 refers to a write bit management table 266 of a primary volume to which the access destination secondary volume corresponds, and determines whether or not the write bit for the write destination slot is ON (S505). When the determination result is negative (NO in S505), the I/O control program 262 sets the write bit for the slot to ON (S506). When the determination result is positive (YES in S505), Step S106 is skipped.

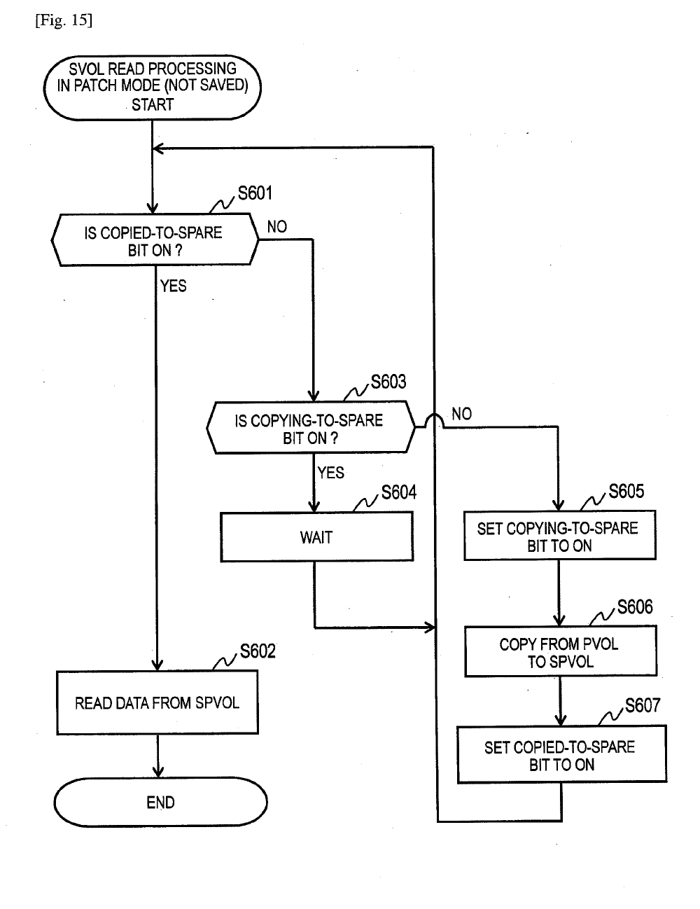

Now, referring to a flowchart of FIG. 15, a description is given of an example of read request processing directed to a secondary volume (SVOL read processing) in the patch mode. The SVOL read processing described here is read processing, as in the SVOL write processing described above referring to FIG. 13, directed to a slot having data which has not been saved from a primary volume to a secondary volume (pool). In other words, the SVOL read processing described here involves data read from the primary volume.

In an example described below, after data is copied from a primary volume to a spare volume (read from the primary volume and write to the spare volume), the data is transferred from the spare volume to the host computer 101 (S602 of FIG. 15). The spare volume may not be used.

In FIG. 15, the I/O control program 262 refers to the read request received from the host computer 101, and identifies a secondary volume and an address area of the read subject. The I/O control program 262 identifies a slot corresponding to the specified address area. On this occasion, it is assumed that the area is included in one slot. When an address area extends to a plurality of slots, the I/O control program 262 carries out steps described below for each of the slots.

The I/O control program 262 refers to the copy-to-spare-volume management table 267, and determines whether or not a copied-to-spare bit for the slot is ON (S601). When the copied-to-spare bit for the slot is OFF (NO in S601), the I/O control program 262 determines, in the copy-to-spare-volume management table 267, the value of the copying-to-spare bit for the slot (S603).

When the value of the copying-to-spare bit is ON, (YES in S603), the I/O control program 262 waits for a predetermined time (S604), and then returns to Step S601. When the value of the copying-to-spare bit for the slot is OFF, (NO in S603), the I/O control program 262 sets, in the copying-to-spare bit column 672 of the copy-to-spare-volume management table 267, the copying-to-spare bit for the slot to ON (S605).

Then, the I/O control program 262 copies the data in the slot in the primary volume (PVOL) to the spare volume (SPVOL) (S606). When the copy has been completed in Step S508, the I/O control program 262 sets, in the copied-to-spare bit column 673 of the copy-to-spare-volume management table 267, the copied-to-spare bit for the slot to ON (S607). Then, the I/O control program 262 returns to Step S601.

When, in Step S601, the copied-to-spare bit for the slot is ON (YES in S601), the I/O control program 262 reads the data of the slot of the access destination from a spare volume (SPVOL), and transfers the data to the host computer 101 (S602).

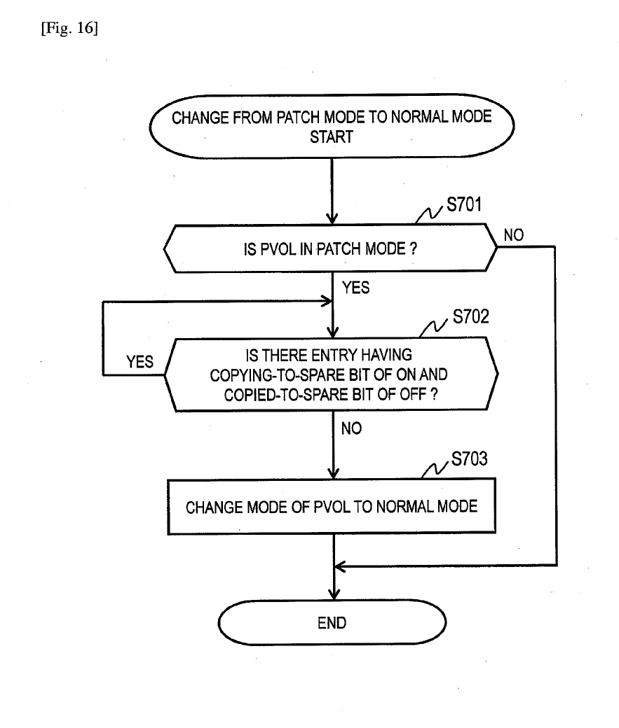

Now, referring to a flowchart of FIG. 16, a description is given of a processing example of switching the mode of a primary volume from the patch mode to the normal mode. The management computer 102 instructs, in response to an input from the administrator, the storage apparatus 101 to control the specified primary volume to transition from the patch mode to the normal mode. The management I/F 202 receives the instruction, and the mode control program 263 is activated. The mode control program 263 may be activated when other conditions are satisfied.

The mode control program 263 refers to the mode management table 265, and determines the mode of the specified primary volume (S701). The mode control program 263 acquires a value from the mode column 653 from a corresponding entry, and when the acquired value represents the normal mode (NO in S701), finishes the flow.

When the acquired value represents the patch mode (YES in S701), the mode control program 263 refers to the copy-to-spare-volume management table 267, and determines whether or not there is an entry (slot) representing an ongoing copy to the spare volume (S702). Specifically, the mode control program 263 determines whether or not, in the copy-to-spare-volume management table 267, there is an entry having the copying-to-spare bit of ON, and the copied-to-spare bit of OFF.

When there is an entry representing an ongoing copy (slot being copied) to the spare volume (YES in S702), the mode control program 263 waits for a predetermined time, and executes again Step S702. This operation prevents a loss of the data. When there is no entry representing an ongoing copy (slot being copied) to the spare volume (NO in S702), the mode control program 263 changes the value of the mode column 653 in the entry of the mode management table 265 to the value representing the normal mode (S703). When the mode of the primary volume is changed from the patch mode to the normal mode, the spare volume is deleted.

As described above, the example monitors, in the state where one primary volume is paired with a plurality of secondary volumes, the write access to the primary volume and the plurality of secondary volumes, and, based on the monitoring result (history of access), determines the type of data in the primary volume. Specifically, the example determines an area to which a write access is not made in the normal mode of the storage apparatus as a master data area.

The above-mentioned example includes the patch mode where even when master data in a primary volume is changed, a copy to secondary volumes is not carried out. By automatically determining whether or not the data is master data based on the access history, for example, when technologies such as the virtual machine and the server virtualization are used, the storage cost can be restrained, and, simultaneously, the storage management cost can be reduced.

The above-mentioned example includes the two primary volume modes, namely, the normal mode and the patch mode. As a result, without saving data before an update of master data such as an OS, the update of the master data can be surely reflected to all secondary volumes. Another example of this invention may have only one mode or more than the two modes of the primary volume. The use of the write bit table enables access control depending on the type of data.

In the above-mentioned example, the storage system includes only one storage apparatus. The storage system may include a plurality of storage apparatus, which is different from the above-mentioned example. For example, primary volumes and secondary volumes may exist on different storage apparatus.

The above-mentioned example determines the type of data based on history of the write access to primary volumes and secondary volumes, and, based on a determination result, controls saving of data before an update in the primary volumes to the secondary volumes. The determination result of the data type may be applied to other access control.

The embodiment of this invention has been described above, but this invention is not limited to the above-mentioned embodiment. The respective components of the above-mentioned embodiment can be easily changed, added, and converted by a person skilled in the art within the scope of this invention.

This invention may be implemented by software running on a processor, or may be implemented by dedicated hardware, or a combination of a processor running based on software and the dedicated hardware. Various programs may be installed on an apparatus by means of a program distribution server or a non-transitory storage medium. According to this invention, the data structure representing information is not limited, and the information may be represented by data structures such as a table, a list, a DB, and a queue, and other data structures. In the information used by this invention, expressions such as “identification information”, “identifier”, “name”, and “ID” are mutually replaceable.

The description has been made above of each processing by mainly using a “program” as a subject (operation subject), but may be made by using a processor as the subject, or may be made by using a device (system) including the processor as the subject, because the program performs predetermined processing by being executed by the processor while using a memory and a network port.

The processor operates based on a program, thereby operating as a functional module for realizing a predetermined function. For example, the processor functions, while operating based on a control program, as a control module, and functions, while operating based on a management program, as a management module. An apparatus and a system containing a processor are an apparatus and a system containing those functional modules.

Information such as programs, tables, and files for realizing the functions can be stored in storage devices such as a non-volatile semiconductor memory, a hard disk drive, and a solid state drive (SSD), or a computer readable non-transitory data storage medium such as an IC card, an SD card, and a DVD.

1. A storage system, comprising:
an interface for transmitting/receiving data to/from a plurality of hosts; and
a controller for processing requests to access a primary volume and a plurality of secondary volumes forming pairs with the primary volume via the interface, wherein:
in each of the plurality of secondary volumes, address areas are defined which are respectively associated with address areas of the primary volume;
each of the plurality of secondary volumes stores differential data with respect to data in the primary volume;
the controller monitors write accesses to the primary volume and the plurality of secondary volumes, and retains a monitoring result; and
the controller controls, based on, in the monitoring result, presence/absence of past write accesses to a plurality of areas in the primary volume and areas respectively corresponding to the plurality of areas in the plurality of secondary volumes, accesses to the primary volume.

2. The storage system according to claim 1, wherein the controller determines, when, in a first write access to the primary volume, the monitoring result represents that there is no past write access to a first area including an access destination area of the first write access, and areas corresponding to the first area in the plurality of secondary volumes, that data in the first area is unnecessary to be saved, and updates the data in the access destination area.

3. The storage system according to claim 2, wherein:
the primary volume has a first mode and a second mode;
the controller saves, in a write access to the primary volume in the first mode, regardless of the monitoring result, when data in a write subject area is yet to be saved to the plurality of secondary volumes, the data to at least one of the plurality of secondary volumes, and then updates the data in the write subject area;
the controller avoids saving, in the write access to the primary volume in the first mode, regardless of the monitoring result, when the data in the write subject area has been saved to the plurality of secondary volumes, the data to the at least one of the plurality of secondary volumes, and updates the data in the write subject area; and
the controller controls the first write access to the primary volume in the second mode.

4. The storage system according to claim 3, wherein the controller generates a spare volume associated with the primary volume in the second mode, copies, in a write access to the primary volume in the second mode, data in an area including a write subject area, to the spare volume, and then updates the data in the write subject area in the primary volume.

5. The storage system according to claim 4, wherein:
the controller copies, in a read access and a write access to a secondary volume in the plurality of secondary volumes in the second mode, when data in an area including an access destination area is required to be acquired from the primary volume, the data required to be acquired from the primary volume to the spare volume; and
the controller acquires, in the read access and the write access to a secondary volume in the plurality of secondary volumes in the second mode, when data in an area including an access destination area exists in the spare volume, the data in the area including the access destination area from the spare volume.

6. The storage system according to claim 3, wherein:
the controller monitors write accesses to the plurality of secondary volumes in the first mode and the second mode; and
in the first mode, the controller monitors write accesses to the primary volume, and, in the second mode, the controller avoids monitoring write accesses to the primary volume.

7. The storage system according to claim 3, wherein:
the controller changes, in accordance with an instruction received from an outside, a mode of the primary volume; and
when the controller receives, during a period of time in which data is being copied to the spare volume, an instruction to change the mode of the primary volume from the second mode to the first mode, the controller waits for an end of the copy of the data, and then changes the mode of the primary volume.

8. The storage system according to claim 2, wherein the controller saves, in the first write access to the primary volume, when the monitoring result represents that there is a past write access to the first area including the access destination area of the first write access, and the areas corresponding to the first area in the plurality of secondary volumes, and data in the first area is yet to be saved, the data in the first area from the primary volume to at least one of the plurality of secondary volumes.

9. The storage system according to claim 1, wherein:
the primary volume has a first mode and a second mode;
the controller transfers, when a read subject secondary volume of a read access received in the first mode retains data in a read subject area, the retained data via the interface;
the controller acquires, when the read subject secondary volume fails to retain the data in the read subject area, one of the data in the read subject area in the primary volume and the data in the read subject area already saved to another secondary volume out of the plurality of secondary volumes, and transfers the acquired data to the interface;
the controller updates, when a write subject secondary volume of a write access received in the first mode retains data in a write subject area, the data in the write subject area in the write subject secondary volume;
the controller acquires, when the write subject secondary volume fails to retain the data in the write subject area, one of data in an area including the write subject area in the primary volume and data in the area including the write subject area already saved to another secondary volume out of the plurality of secondary volumes, and stores data acquired by updating the acquired data in the write subject secondary volume;
the controller saves, in a write access to the primary volume in the first mode, regardless of the monitoring result, when data in a write subject area is yet to be saved to the plurality of secondary volumes, the data to at least one of the plurality of secondary volumes, and then updates the data in the write subject area;
the controller avoids saving, in the write access to the primary volume in the first mode, regardless of the monitoring result, when the data in the write subject area has been saved to the plurality of secondary volumes, the data to the at least one of the plurality of secondary volumes, and updates the data in the write subject area; and
the controller determines, in control of a first write access to the primary volume in the second mode, based on presence/absence of a past write access to a first area including an access destination area of the first write access and areas corresponding to the first area in the plurality of secondary volumes, necessity to save data in the first area.

10. A control method for a storage system for processing a request to access a primary volume and a plurality of secondary volumes forming pairs to the primary volume,
the plurality of secondary volumes each having address areas defined therein, which are respectively associated with address areas of the primary volume,
the plurality of secondary volumes each storing differential data with respect to data in the primary volume,
the control method comprising:
monitoring write accesses to the primary volume and the plurality of secondary volumes, and retaining a monitoring result; and
controlling, based on, in the monitoring result, presence/absence of past write accesses to a plurality of areas in the primary volume and areas respectively corresponding to the plurality of areas in the plurality of secondary volumes, accesses to the primary volume.

11. The control method for a storage system according to claim 10, further comprising, in a first write access to the primary volume, based on, in the monitoring result, presence/absence of a past write access to a first area including an access destination area of the first write access and areas corresponding to the first area in the plurality of secondary volumes, determining necessity to save data in the first area.

12. The control method for a storage system according to claim 11, further comprising:
when, in a first write access to the primary volume, the monitoring result represents that there is no past write access to a first area including an access destination area of the first write access, and areas corresponding to the first area in the plurality of secondary volumes, determining that the data in the first area is unnecessary to be saved, and updating the data in the access destination area; and
in the first write access to the primary volume, when the monitoring result represents that there is a past write access to the first area including the access destination area of the first write access, and the areas corresponding to the first area in the plurality of secondary volumes, and data in the first area is yet to be saved, saving the data in the first area from the primary volume to at least one of the plurality of secondary volumes, and then updating the data in the access destination area.

13. The control method for a storage system according to claim 10, wherein:
the primary volume has a first mode and a second mode; and
the control method further comprises:
saving, in a write access to the primary volume in the first mode, regardless of the monitoring result, when data in a write subject area is yet to be saved to the plurality of secondary volumes, the data to at least one of the plurality of secondary volumes, and then updating the data in the write subject area;
avoiding saving, in the write access to the primary volume in the first mode, regardless of the monitoring result, when the data in the write subject area has been saved to the plurality of secondary volumes, the data to the at least one of the plurality of secondary volumes, and updating the data in the write subject area; and
controlling an access to the primary volume in the second mode based on the presence/absence of the past write access.
